(19) United States
(12) Patent Application Publication
(10) Pub. No.: US 2011/0208639 A1
(43) Pub. Date: Aug. 25, 2011

(54) IDENTITY VALIDATION FOR FINANCIAL TRANSACTIONS

(76) Inventors: Erik Peterson, Marietta, GA (US); Nagesh Kadaba, Roswell, GA (US)

(21) Appl. No.: 13/098,682

(22) Filed: May 2, 2011

Related U.S. Application Data
(63) Continuation of application No. 12/397,720, filed on Mar. 4, 2009.

(51) Int. Cl. G06Q 40/00

(52) U.S. Cl. 705/38

(57) ABSTRACT

Systems and methods for validating a party's identity for facilitating peer-to-peer loan transactions are provided. Drivers of a fleet of parcel delivery vehicles associated with a particular common carrier are used to collect information validating a party's identity. As part of a scheduled parcel delivery, or as an independent stop specifically for identity validation, a driver visits an address associated with a party (e.g., a consignor or consignee) and confirms the party's association with the address, such as by visually inspecting the party's driver's license or other identifying document. Information regarding the party's association is provided to a system accessible by a peer-to-peer lending facilitator. Input from the drivers relating to the association may be transmitted to a server via the driver's handheld device. The information can be used by the peer-to-peer lending facilitator to determine a level of risk associated with entering into a loan transaction with the party.

### CROSS REFERENCE TO RELATED APPLICATIONS

This application is a continuation application of U.S. patent application Ser. No. 12/397,720 filed Mar. 4, 2009, which is hereby incorporated herein in its entirety by reference.

### TECHNOLOGICAL FIELD

Embodiments of the present invention relate generally to validating the identity of business entities and individuals engaged in loan transactions and, more particularly, relate to systems and methods for validating the identity of lenders and borrowers for facilitating web-based loan transactions.

### BACKGROUND

Over the years, use of the Internet has grown to touch almost every facet of people's lives. In the business world, the Internet has been used to advertise goods and services, receive orders for products, and facilitate communication within and among businesses. The Internet has also become a place where borrowers and lenders can find each other, agree to the terms of a loan transaction, and transfer funds. Peer-to-peer lending websites have thus developed to facilitate such transactions and to provide a forum for borrowers and lenders to conduct business.

In one type of peer-to-peer lending scenario, typically a potential borrower (e.g., an individual wishing to take out a loan) will post an amount that he wishes to borrow and a maximum interest rate he is willing to pay. In some cases, the potential borrower may include a short description of the purpose of the loan, such as to go to college, start a business, or buy a car. A potential lender (e.g., an individual who is seeking to loan money for interest) can then bid on specific loans by offering to lend the potential borrower some or all of the money requested by the potential borrower in exchange for a minimum interest rate specified by the potential lender. A third party, such as a hosting website or web forum, may then match borrowers with appropriate lenders and facilitate the transaction between the parties.

Because such peer-to-peer loan transactions occur in cyberspace, it can be difficult to fully asses the risks involved in lending money to a particular borrower. Thus, there is a need for validating a party's identity in an efficient and cost-effective manner and providing the information to potential borrowers and lenders so as to facilitate peer-to-peer loan transactions.

### BRIEF SUMMARY

In general, embodiments of the present invention provide systems, methods, apparatus, and computer program products for collecting residence information.

In accordance with one aspect, a method for collecting residence information is provided. In one embodiment, the method comprises (1) identifying a delivery route corresponding to the address; (2) incorporating the address to the delivery route; (3) transmitting the delivery route comprising the incorporated address to a delivery driver's computing device, wherein the delivery driver is scheduled to drive the delivery route; (4) receiving the residence information associated with the address, the residence information collected from an in-person visit to the address by the delivery driver; and (5) providing the residence information to the third-party.

In accordance with yet another aspect, an apparatus comprising at least one processor and at least one memory including computer program code is provided. In one embodiment, the at least one memory and the computer program code may be configured to, with the processor, cause the apparatus to at least (1) receive a request from a third-party to collect residence information associated with an address, wherein the residence information is to be collected as part of an in-person visit to the address; (2) identify a delivery route corresponding to the address; (3) incorporate the address to the delivery route; (4) transmit the delivery route comprising the incorporated address to a delivery driver's computing device, wherein the delivery driver is scheduled to drive the delivery route; (5) receive the residence information associated with the address, the residence information collected from an in-person visit to the address by the delivery driver; and (5) provide the residence information to the third-party.

In accordance with yet another aspect, a computer program product for collecting residence information is provided. The computer program product may comprise at least one computer-readable storage medium having computer-readable program code portions stored therein, the computer-readable program code portions comprising executable portions configured to (1) receive a request from a third-party to collect residence information associated with an address, wherein the residence information is to be collected as part of an in-person visit to the address; (2) identify a delivery route corresponding to the address; (3) incorporate the address to the delivery route; (4) transmit the delivery route comprising the incorporated address to a delivery driver's computing device, wherein the delivery driver is scheduled to drive the delivery route; (5) receive the residence information associated with the address, the residence information collected from an in-person visit to the address by the delivery driver; and (5) provide the residence information to the third-party.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 illustrates a scenario in which the party whose identity is to be validated is a consignor or consignee of a parcel delivery transaction according to an exemplary embodiment of the present invention;

FIG. 2 illustrates a scenario in which the party whose identity is to be validated is not a consignor or consignee of a parcel delivery transaction according to an exemplary embodiment of the present invention;

FIG. 3A depicts a delivery route according to an exemplary embodiment of the present invention;

FIG. 3B depicts the delivery route of FIG. 3A in tabular form according to an exemplary embodiment of the present invention;

FIG. 4 is a network diagram of a system for validating a party's identity via a network according to an exemplary embodiment of the present invention;

FIG. 5 illustrates a data terminal for transmitting input according to an exemplary embodiment of the present invention;

FIG. 6 illustrates information in a database including an indication of validity according to an exemplary embodiment of the present invention;

FIG. 7 illustrates extraction of validated entries according to an exemplary embodiment of the present invention; and

FIG. 8 is a block diagram illustrating a method for validating a party's identity according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

Systems, methods, and computer program products of various embodiments of the present invention provide for validating a party's identity for facilitating peer-to-peer loan transactions. In general, fleet vehicle drivers (e.g., drivers of vehicles within a fleet of parcel delivery vehicles associated with a particular common carrier) are used to collect information validating a party's identity. Such information may include driver's license information, visual confirmation of the party's identity, and/or residence information.

The validating information is then made accessible to a peer-to-peer lending facilitator. For example, as described below, the validating information may be stored in a database accessible by servers of a peer-to-peer website, such as Prosper.com or Zopa.com. The peer-to-peer website may, in turn, use the information to determine the risk involved with lending funds to a particular individual and may present the risk assessment to potential borrowers and lenders. By providing an indication of the risk involved with loaning money to a certain individual, the peer-to-peer website can help potential lenders determine the appropriate amount of interest to charge and inform the lender's decision on whether to engage a particular borrower in a loan transaction.

In the past, such websites have assessed the risks (or relied on a third-party's assessment of the risks) of entering into a loan with a particular potential borrower based on the potential borrower's credit history and other financial data. However, when a loan transaction occurs entirely (or almost entirely) in cyberspace, some risk factors may not be easy to identify. For example, a potential borrower may misidentify himself as a different individual in order to qualify for low interest rates, or to fraudulently obtain money that he has no intention of repaying. By providing a validation of the borrower's identity through a face-to-face interaction as described below, the determination of risk may be more complete and may better represent the actual risk involved with entering into a particular loan transaction.

At the same time, a lender may misrepresent his identity for various reasons, such as to obtain personal and/or confidential information from a potential borrower. The validation of a lender's identity may, at the very least, provide a hesitant borrower with some level of assurance that the lender exists and has accurately represented his identity, thereby encouraging the borrower to engage in a loan transaction with a particular lender. Thus, providing a validation of identity based on a face-to-face meeting may provide an additional level of security and allow the peer-to-peer loan facilitator's risk assessment to be more comprehensive.

According to various embodiments of the present invention, the identity of a party is validated by visiting the party or the party's representative (e.g., when the party is a business entity) at an address associated with the party, confirming the party's association with the address (e.g., confirming that the address is the party's residence), and providing an indication of validity to third parties. For example, the party, once validated, may be listed as a “validated party” or the name of the party may be made available to a third party requestor once the party has been validated, as described more fully below. Although it is understood that the identities of both borrowers and lenders may be validated according to the described embodiments, the description that follows refers mostly to the validation of a potential borrower's identity. However, it should be understood that the same or similar techniques could be used for validating a potential lender's identity, or the identity of other individuals or businesses.

### VISITING THE PARTY

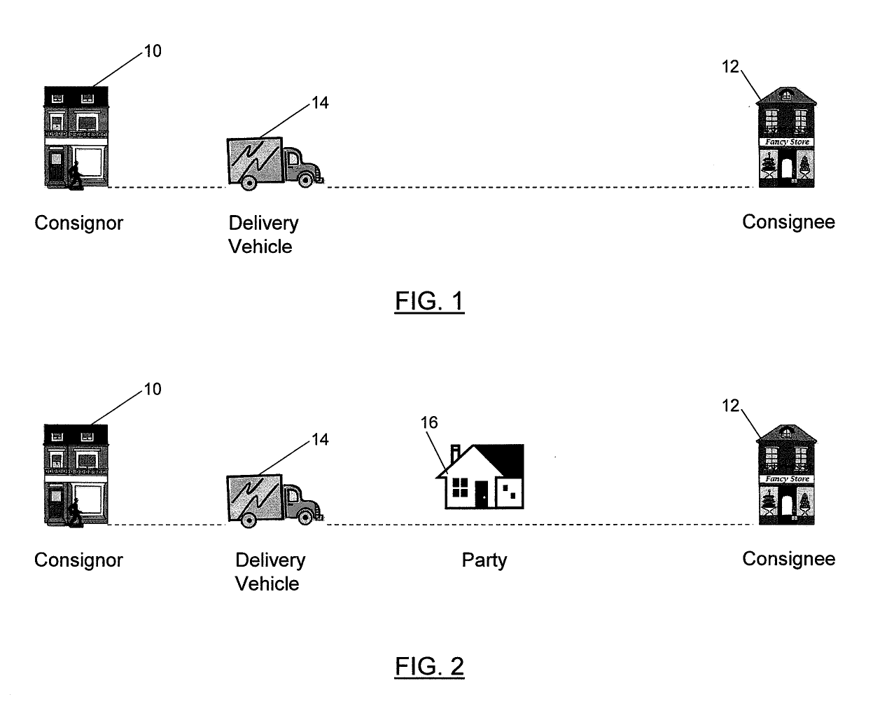

With reference to FIGS. 1 and 2, data validating the identity of a particular borrower can be obtained in many ways. In some embodiments, the data is gathered by drivers of a fleet of parcel delivery vehicles during the course of normal operation, such as when the vehicle is en route from a shipment origin (such as the consignor's address or common carrier distribution center) to a delivery destination (such as the consignee's address or common carrier distribution center). In this scenario, the party whose identity is being validated may be the consignor or the consignee. Alternatively the party may be someone other than the consignor or the consignee, but may be located along or close to the delivery route of a particular parcel delivery vehicle, as described in greater detail below.

### Party is a Consignor or Consignee

In some cases, the party whose identity is to be validated may be the consignor or the consignee in a parcel delivery transaction. In a typical parcel delivery transaction, multiple parcel delivery vehicles may be involved in transporting a parcel from the consignor to the consignee. In some cases, the parcel delivery vehicles may be employed by the same common carrier, whereas in other cases more than one common carrier may be involved. Furthermore, a single parcel delivery vehicle may pick up several parcels from several different consignors and/or deliver parcels to several different consignees. In some cases, a particular parcel delivery vehicle may pick up parcels from different consignors and deliver the parcels to a distribution center associated with a common carrier, where the parcels may be sorted and loaded onto other delivery vehicles for transportation to the various consignee locations. Similarly, a particular parcel delivery vehicle may pick up several parcels from the common carrier's distribution center and deliver the parcels to the respective consignees.

FIG. 1 depicts a simplified scenario in which a parcel delivery vehicle 14 associated with a common carrier is delivering a parcel from a consignor 10 to a consignee 12. The party whose identity is to be validated, in this case, may be the consignor 10 or the consignee 12. In other words, in this example, the party is himself either shipping or receiving a parcel. Thus, in this case, the validation may occur at the same time that the parcel is picked up from the party (as consignor) for shipment or given to the party (as consignee) for delivery. In other words, because the driver is at the party's address to execute a delivery transaction (e.g., receive a parcel or deliver a parcel), the validation of the party's identity may occur during the same process of shipping or delivering the parcel.

### Party is Not a Consignor or Consignee

In FIG. 2, another scenario is depicted in which a delivery vehicle validates the identity of a party who is not a consignor 10 or a consignee 12, but rather is located between the locations of a consignor 10 and a consignee 12. Thus, in FIG. 2, the residence of a party 16 is located along or close to the route of the delivery vehicle 14 as the delivery vehicle 14 travels from a consignor 10 to a consignee 12. For example, the delivery vehicle 14 in this case may be picking up one parcel from the consignor 10 and may be delivering another, different parcel to the consignee 12. Likewise, in a variation of the scenario shown in FIG. 2, the residence of the party 16 may be located between two consignors or two consignees as the delivery vehicle 14 picks up parcels and/or deliver parcels. Either way, the party 16 in these scenarios is not a consignor 10 or a consignee 12, but is rather located along/near the delivery route such that it is possible for the driver to stop at the party's address to validate the party's identity without substantially deviating from the driver's scheduled delivery route.

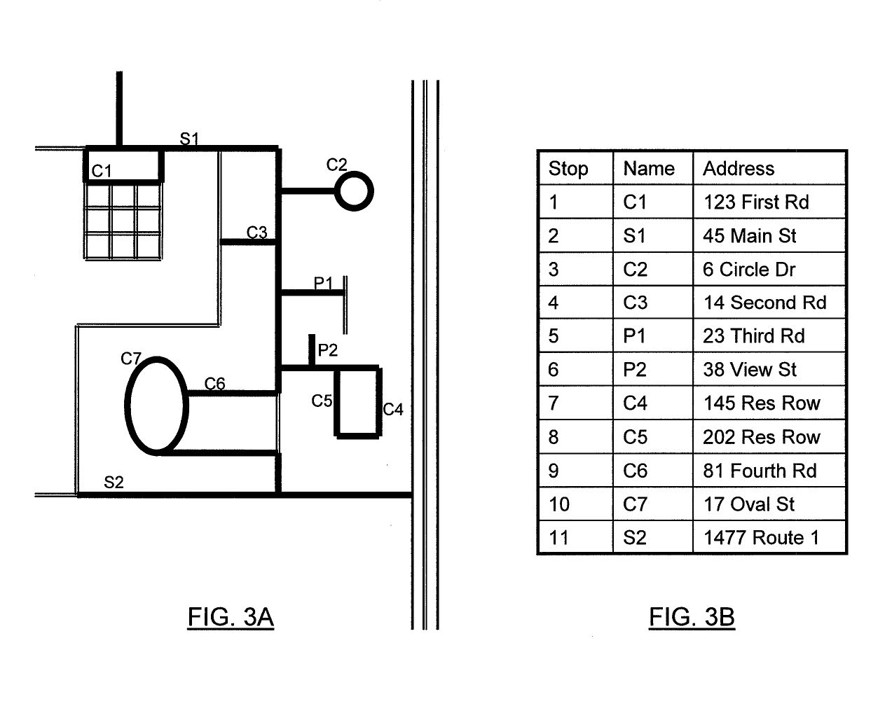

In some cases, the address of the party 16 may be a planned stop on the driver's route, such that the address becomes part of the route, even though no pick-ups or deliveries are scheduled to take place at that address. For example, a driver of a particular delivery vehicle may have a morning route scheduled by the common carrier that includes various parcel pick-ups and deliveries, as shown in FIGS. 3A and 3B. FIG. 3A shows a mapped route of the delivery vehicle of this example, and FIG. 3B lists the route in tabular form, showing the various stops that the delivery vehicle would be making. In the figures, the address of each consignee is designated by an alphanumeric code beginning with the letter “C,” the address of each consignor is designated by an alphanumeric code beginning with the letter “S,” and the address of each party whose identification is to be validated is designated by an alphanumeric code beginning with the letter “P.” Thus, in this particular route, there are two consignors, seven consignees, and two parties to be validated.

Although parcels are not being picked up from or delivered to the parties P1 and P2 listed on the route in FIGS. 3A and FIG. 3B, the parties are incorporated into the route such that the delivery vehicle may stop at the address of each party as part of the parcel delivery activities the driver is conducting on behalf of the common carrier. Furthermore, although a party's address may not be directly on the delivery route, the delivery route may be modified to take into account the address of the party. For example, although P1 is not located on a road where any other consignors or consignees are located, the driver's route may be modified to include the address of P1 as a stop along the route, as shown.

It is noted that although the description herein discusses validating a party's identity in person during or in the process of conducting parcel delivery transactions, the common carrier may be able to verify parties' identities remotely by virtue of its extensive databases of information on the people and businesses that it delivers to and picks up from. In other words, a common carrier may not necessarily need to instruct a driver to visit a party's address in order to confirm the existence of some businesses or individuals at the particular address. The common carrier's records may already provide sufficient assurances that the party is at the address indicated on a loan application (for example) by virtue of prior dealings between the common carrier and the party as a consignor or consignee. However, in this situation, the common carrier may need to ask the party if the party is a potential party to a loan transaction. Thus, the common carrier may contact the party by e-mail, telephone, or other form of communication to confirm that the party is indeed a potential party to a loan transaction.

### VALIDATING THE PARTY'S IDENTITY

After a fleet vehicle delivery driver has arrived at the address of a party whose identity is to be validated, the party's involvement in a loan transaction and his association with the address may be confirmed. An indication of validity may then be provided to a system accessible by users of a peer-to-peer lending application, as described below.

Confirming the Party's Involvement with a Loan Transaction

As an initial matter, before confirming the party's name and address or otherwise validating the party's identity, the driver may confirm that the party is indeed involved with a loan transaction (e.g., signed up as a potential borrower or lender with a peer-to-peer lending facilitator). Thus, upon arriving at the party's address, the driver may ask for the person at issue. Once the person has identified himself, the driver may then ask whether the person has requested to take out a loan via the peer-to-peer website at issue (or to loan money on the website). Then, if the answer is “yes,” then the driver would proceed to verify the person's identity, as described below. Confirming the party's involvement with a loan transaction may thus serve to protect a lender from a potential identity fraud situation.

Confirming the Party's Association with the Address

Regardless of whether the party is a consignor or consignee of the parcel delivery transaction or is located on or near the delivery route, confirmation of the party's association with the address may occur in a number of ways. For example, the driver of the parcel delivery vehicle may confirm the party's association by requesting to see a form of identification, such as a driver's license, a picture identification card, utility bill, a credit card that includes a picture of the individual, a government distributed picture identification, or other picture identification. In this way, the driver may visually verify that the party standing before him has the same name as the individual represented on the form of identification tendered and has the same appearance as the individual pictured on the identification document. For example, the driver may confirm that the person standing before him looks like the person pictured on the party's driver's license and that the name printed on the driver's license matches the name of the party whose identity is to be validated.

In addition to verifying the party's identity, the driver may also visually verify the party's address using a driver's license, picture ID, utility bill, or credit card, among other documents. For example, the driver may compare the address printed on the party's driver's license with the address provided on a parcel being shipped to the individual or otherwise provided to the driver as part of the instructions to visit the particular party.

In some cases, such as when the party is a consignor or consignee as described above, confirmation of the party's presence may be incidental to an activity related to the party's shipment or receipt of a parcel. For example, the party (who may also happen to be a consignor) may need to pay the cost of shipping a parcel. The party may decide to pay using a credit card, which he may swipe at a point-of-sale device that the driver may be carrying with him. In some cases, the driver may be carrying a handheld device such as a Delivery Information Acquisition Device (DIAD), which may also include or function as a point-of-sale device. In addition to paying the shipping charges, however, swiping the credit card may also serve to validate the consignor's identity. For example, the name and address associated with the credit card may be read by the DIAD and automatically compared with the name and address of the consignor (based on the common carrier's shipment and delivery records). Matching information may serve as an automatic confirmation of the party's association with the address as a result of the credit card transaction, as described in greater detail below.

### Providing the Indication of Validity

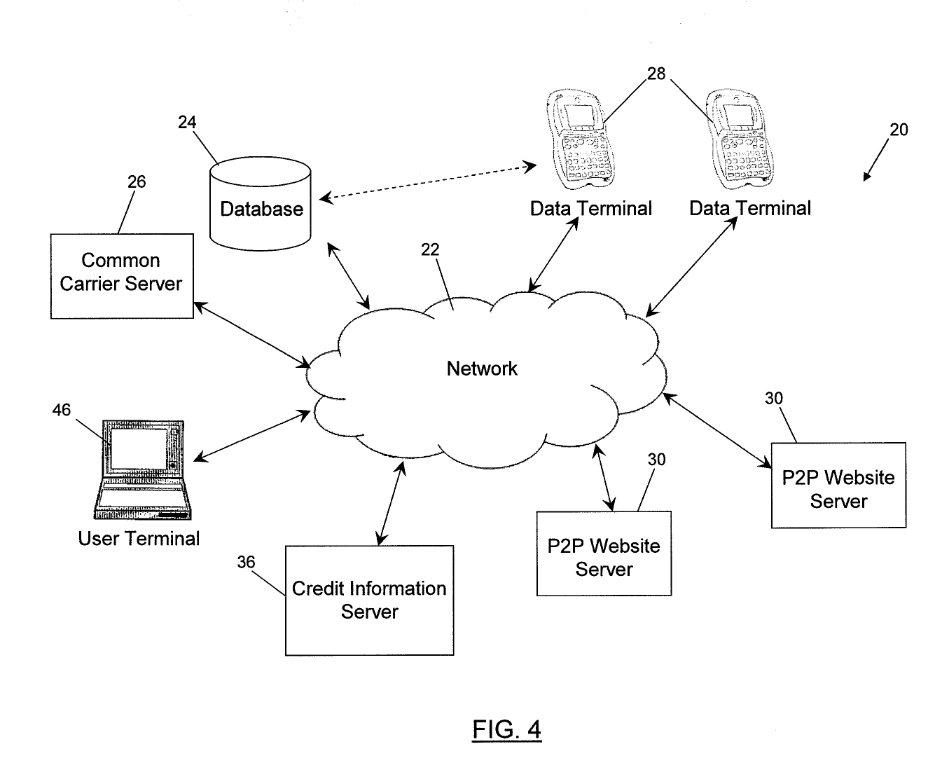

In some embodiments, information regarding the validity of a party's identity is communicated and stored on a computer system that includes various components communicating via a network, such as the network 22 shown in FIG. 4. In some cases, for example, the network 22 could be the Internet. Referring to FIG. 4, the system 20 may include a database 24 that is connected to the communications network 22 and is configured to store a plurality of data entries regarding parcel delivery transactions and/or other types of data. For example, information such as the name, address, and/or account number of consignors and consignees of the common carrier may be stored in the database 24 and maintained by the common carrier. The system 20 may also include one or more servers 26 that are associated with a common carrier. These servers 26 may be configured to access the database 24 via the network 22 in order to update entries and manage the stored information, as necessary.

The computer system 20 may also include one or more data terminals 28 that are connected to the communications network 22 and are configured to receive and transmit data. The data terminal 28 may, for example, be a computer, such as a desktop or laptop computer, a cellular telephone, a barcode scanner, point-of-sale device, a personal digital assistant (PDA), an electronic signature pad, a handheld device such as a DIAD, or any other device configured to receive input either directly or indirectly from a user. For example, the data terminals 28 may be DIADs that are carried by drivers of a fleet of delivery vehicles of the common carrier and may be used by the common carrier to communicate with each driver, such as to provide information to the drivers regarding consignor/consignee names and addresses.

The common carrier server 26 may include and/or be in communication with one or more processors (not shown) configured to access and manipulate the data in the database 24. The server 26 may therefore be configured to access the database 24 and to provide an indication of the validity of the party's identity to the database based on the input received via the data terminals 28. The common carrier server 26 may include a memory component for storing data entries regarding parcel delivery transactions, as well as an indication of the validity of a party's identity, and/or the common carrier server 26 may communicate the information and indications to the database 24 for storage. In some cases, the database 24 is included in and forms a part of the common carrier server 26.

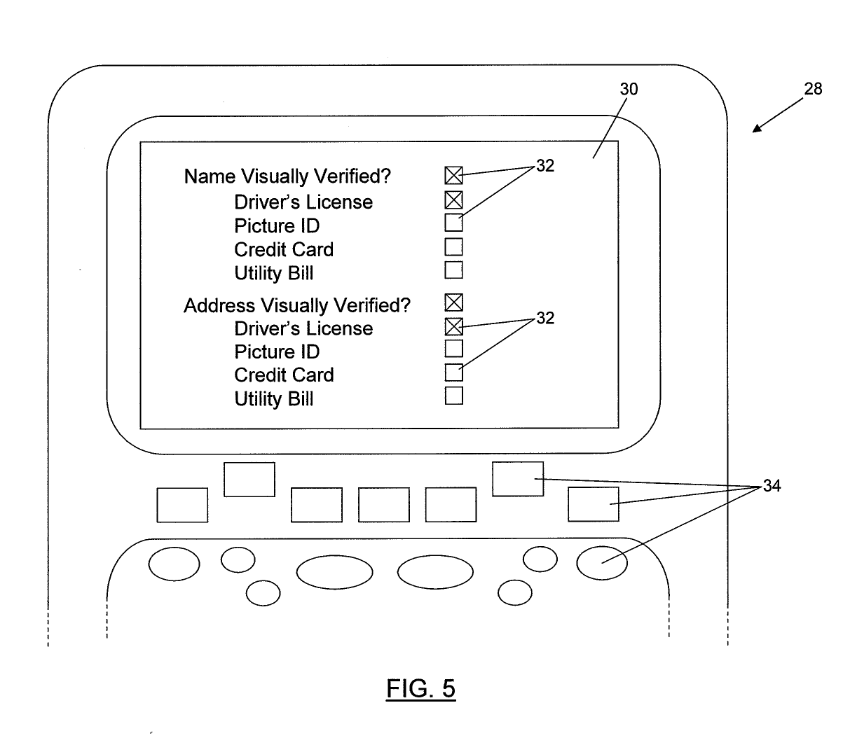

Each data terminal (e.g., each DIAD) may be configured to receive and transmit input relating to a party's identity. For example, the data terminal 28 may be configured to receive input from a driver indicating that the party's identity is accurate. Referring to FIG. 5, the driver may receive a prompt on the screen 30 of the data terminal 28 upon visiting the address of a party that asks whether the name of the party has been verified, as shown in FIG. 5. The prompt may appear automatically, for example, after receiving the party's signature on a DIAD upon receipt or delivery of a parcel if the party is a consignor or consignee according to FIG. 1. Alternatively, the driver may cause the prompt to appear by selecting the name of a party from a list of scheduled stops along a route according to FIG. 2, such as the list of stops shown in FIG. 3B.

In various embodiments, the data terminal 28 is adapted to allow the driver to respond to the prompt by marking a check box 32 using the keys 34 of the data terminal or other input mechanism to indicate that the party is indeed involved in a loan transaction and that a visual inspection was performed. Furthermore, the data terminal 28 may receive input regarding the method of validation, such as what form of documentation was visually inspected. The data terminal 28 may also prompt the driver to indicate whether the address of the party was verified and which form of documentation was used to validate the party's address, in addition to other items of information regarding the identity of the party.

The DIAD, barcode scanner, or other data terminal 28 may transmit the input received to the database 24 via the network 22. For example, the DIAD may transmit the data wirelessly (e.g., in real time) via a cellular connection or Bluetooth® connection to another device, such as a receiver carried by a vehicle associated with the DIAD (e.g., the driver's vehicle) and/or the common carrier server 26, which may then transmit the data to the database 24. As another example, the driver's vehicle may wirelessly communicate with the DIAD or may include a cradle for docking the DIAD, in which case information received by the DIAD may be uploaded to the common carrier server 26 via the cradle or other transmitter carried by the vehicle. The data may be transmitted any other suitable way, for example, according to the common carrier's preferences.

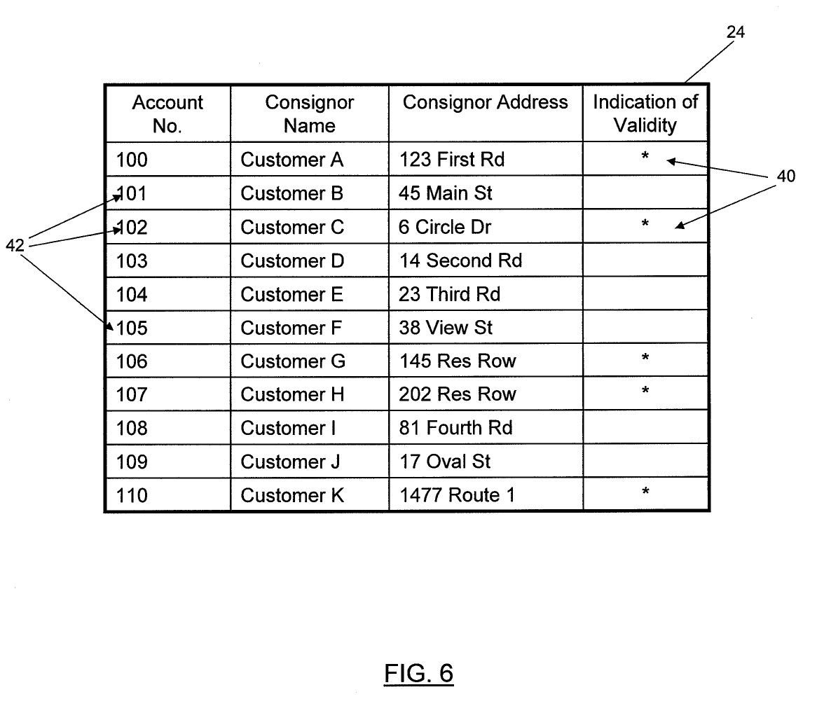

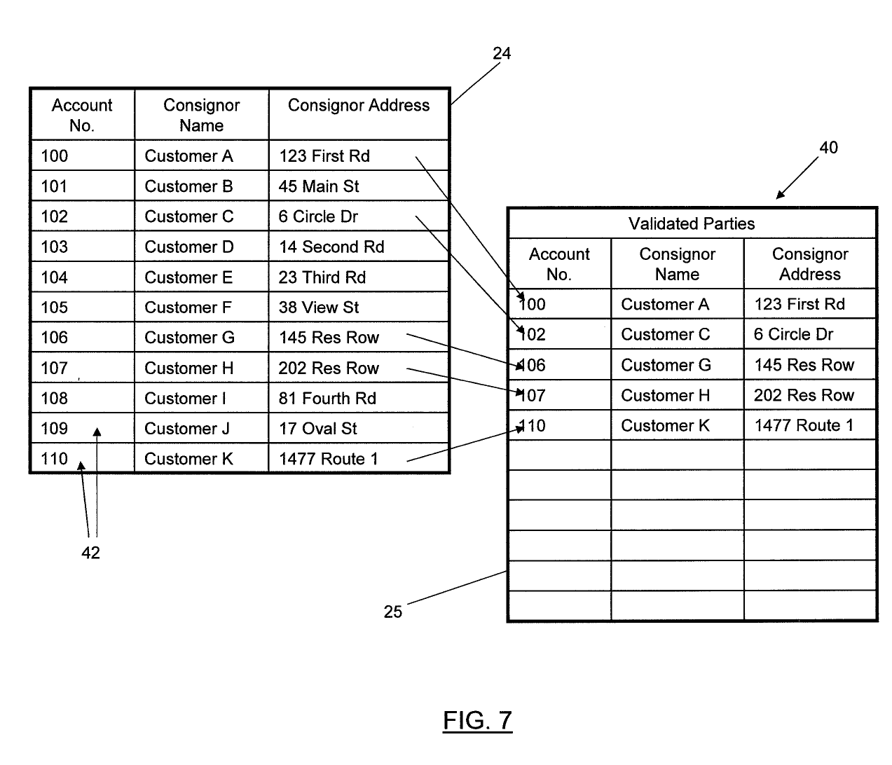

In any case, the common carrier server 26 or other processor may be configured to receive the data (e.g., the responses of the driver to the prompts displayed on the data terminal) and to provide an indication 40 to the database 24 of the validity of the party's identity. The indication may include a designation of the party's information as “validated,” as shown in FIG. 6. In some cases, the indication 40 includes extraction of the particular party's information 42 and listing of the information in a separate database 25 or area of memory reserved for validated parties, as shown in FIG. 7.

In some cases, the data is transmitted automatically from the data terminal 28 to the common carrier server 26, such as when the data terminal is used as a point of sale device to receive credit card information. In this example, the information read from the credit card may be automatically transmitted to the common carrier server 26 and recorded in the database 24 via the communications network 22 shown in FIG. 4. The common carrier server 26 may, in some cases, be configured to correlate the data with information regarding one or more parcel delivery transactions associated with the party. For example, the server 26 may be configured to compare the credit card information received (e.g., the card carrier's name and address) to information already stored in the database 24 regarding the consignor or consignee's delivery information (e.g., the consignee's name and delivery address, obtained as a result of previous parcel delivery transactions with the party as a consignee).

Referring again to FIG. 6, in some cases, the database 24 may include information 42 regarding a consignor's name and address for a particular delivery that is to be conducted by the driver. When the consignor (who, in this example, is a party whose identity is to be validated) swipes his credit card to pay for the delivery services, the card holder's name and address may be automatically transmitted to the common carrier server 26. The server 26 may then access the previously stored information from the database 24 and compare it to the credit card information. If the consignor name matches the credit card holder's name and the consignor's address matches the credit card holder's address, for example, the server 26 may save, to the system's memory, an indication 40 of the validity of the party's identity.

### PROVIDING THE INFORMATION TO THIRD PARTIES

Once the party's presence at the address has been confirmed (e.g., the party's identity and address have been validated) and the indication 40 of validity has been associated with the validated party (e.g., within a database 24), the information may be accessed for use by third parties. In this regard, in various embodiments, the system 20 (or at least parts of the system 20) shown in FIG. 4, which may be a first computer system, may be accessible by a second computer system, such as a third-party system, that is configured to facilitate peer-to-peer loan transactions. In this way, a third-party loan facilitator, such as a company managing a peer-to-peer lending website, can access the validating information and use the information to determine a level of risk associated with engaging the party in a peer-to-peer loan transaction (e.g., lending money to a particular borrower or borrowing money from a particular lender).

For example, referring to FIG. 4, one or more peer-to-peer website servers 30 may be connected to the communications network 22 and may be configured to access portions of the database 24 or common carrier server 26 to determine whether the identities of particular parties are validated. In some embodiments, the peer-to-peer website server 30 or common carrier server 26 may be configured to search the database for a particular party and determine whether the party's information is associated with an indication of validity. In other embodiments, the common carrier server 26 may be configured to transmit data regarding validated parties to the peer-to-peer website server 30. Thus, the peer-to-peer website server 30 may incorporate the validation of the party's identity (or lack thereof) as one of the factors informing the determination of a level of risk associated with the particular party.

For example, the peer-to-peer website server 30 may be configured to obtain financial histories and credit scores from other sources, such as a credit information server 36 maintained by a credit bureau, and may use such statistics to give a party a rating. The peer-to-peer website server 30 may also be configured to determine whether the party's identity has been validated (e.g., by communicating with the common carrier server 26). If the identity has been validated, the peer-to-peer website server 30 may modify the risk rating score to reflect less risk associated with entering into a loan transaction with the party. If the identity has not been validated, or, for example, if the validation has shown that the party's information is fraudulent, the peer-to-peer website server 30 may modify the risk rating score to reflect more risk associated with entering into the loan transaction.

For example, the peer-to-peer website server 30 may issue a score of A for Excellent, B for Good, C for Fair, and D for Poor based solely on information acquired regarding the party's credit risk. Upon incorporating the indication of validity 40 recorded in the database 24 and/or transmitted by the common carrier server 26, however, the peer-to-peer website server 30 may modify the risk rating to A+ for those parties with Excellent credit scores and a validated identity, B+ for those parties with Good credit scores and a validated identity, and so on.

The rating, in turn, may be displayed on the peer-to-peer lending website such that prospective borrowers and lenders may be able to view the ratings associated with various parties listed on the website. For example, a prospective lender may operate a user terminal 46 connected (directly or indirectly) to the network 22 to view the ratings associated with various parties looking to secure a loan. By considering the ratings along with other information describing the parties and the respective loans requested, the lender may be able to decide whether she wishes to loan an amount of money to a particular borrower.

In some cases, the common carrier server 26 may be configured to receive requests from the third party server indicating the party to be verified. For example, the peer-to-peer website server 30 may transmit a request to the common carrier server 26 indicating that validation of Mr. John J. Borrower is needed. The request may be the result of an inquiry made by a potential lender who is interested in lending to Mr. Borrower, but who would like to know first if Mr. Borrower's identity is authentic. Similarly, the request may be generated as a result of a new request for a loan initiated by Mr. Borrower. For example, the request may be generated automatically when Mr. Borrower signs up on the peer-to-peer lending website to apply for a loan.

Thus, the common carrier server 26 may be configured to query the database 24 for entries matching the requested party. If the entries are not found, then the common carrier server 26 may be configured to transmit the request for validation to at least one particular DIAD based on the address of the party to be validated and the planned delivery route to be executed by the user of the DIAD.

For example, referring to FIG. 3A, Mr. John J. Borrower may reside at 28 Oval St. (near consignee C7). Thus, in the case where an entry for Mr. John J. Borrower is not found in the database 24 (e.g., because Borrower's identity has not been validated previously), the common carrier server 26 may incorporate a stop at Borrower's address into the driver's route shown in FIGS. 3A and 3B based on the proximity of Borrower's address to other addresses along the driver's route. In this way, the driver's route may include Borrower's address as a stop along the route, along with instructions to the driver to validate Borrower's identity.

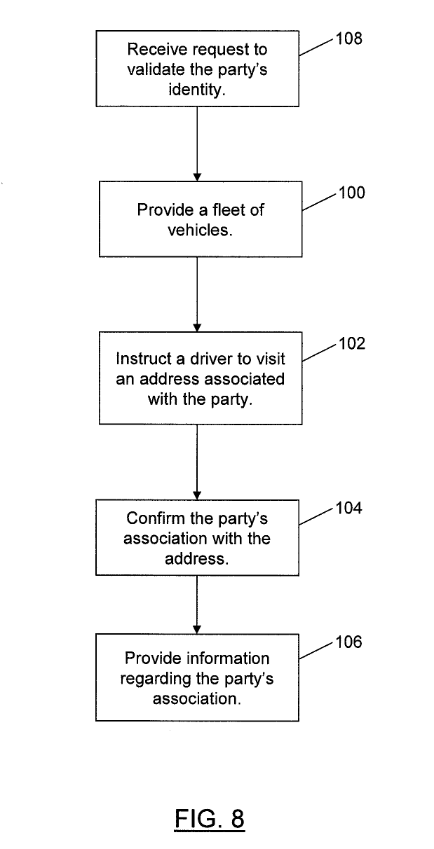

The method for validating a party's identity described above is summarized in FIG. 8. Referring to Blocks 100 and 102 of FIG. 8, a fleet of vehicles is provided and a driver of one of the vehicles is instructed to visit an address associated with the party as part of a parcel delivery transaction. The address of a party whose identity is to be validated is then visited by the driver. As described above, the party may also be a consignor or consignee, and so the visit may be coincident with a parcel delivery transaction, such as the pick-up or delivery of a parcel. In other cases, the party may be visited as part of the execution of a delivery route, such as when the party is located on or near a delivery route but is not a consignor or consignee.

The party's association with the address is then confirmed, for example, by the driver of a parcel delivery vehicle. See block 104. The confirmation may include the driver asking the party if the party is involved with a loan transaction and/or visually verifying the party's name and/or address using one or more documents such as the party's driver's license, picture identification, utility bill, or credit card. In some cases, the confirmation may include automatically confirming the party's name and address as a result of a credit card transaction. The party's name and/or address may be compared to information regarding a consignor or consignee of a parcel delivery transaction, such as when information has previously been stored regarding the party as a consignor or consignee as a result of a parcel delivery transaction, as described above.

In block 106, information regarding the party's association is provided to a computer system accessible by a peer-to-peer lending facilitator. For example, the information, which may comprise data transmitted by the driver in the previous example (e.g., via a handheld device, such as a DIAD) to a common carrier server, may be made accessible to a second computer system, such as a server of a peer-to-peer lending website. The information may include an indication of validity, which the peer-to-peer website server may then incorporate into its assessment of the risk involved with entering into a loan transaction with the party, as described above.

In some cases, a request to validate the party's identity may be received, thereby causing a common carrier to instruct a driver to visit the address of the requested party. See block 108. The request may, for example, be initiated by the peer-to-peer lending facilitator. Such a request received by the common carrier server may be relayed to one or more particular drivers in the field based on the address of the party with respect to the driver's route. In this way, the driver may visit the address and validate the party's identity in response to the request without substantially deviating from the driver's scheduled delivery route.

The steps described above need not occur in the order shown in FIG. 8 or discussed above. Rather, the steps may occur in any order according to the configuration of the system and the preferences of the common carrier and/or peer-to-peer website administrator. For example, in some cases, the information regarding the party's association may be transmitted simultaneously with the confirmation of the party's presence at the address. Furthermore, the methods described above may be implemented using fleets of vehicles other than fleets of delivery vehicles and in contexts other than peer-to-peer lending.

Many modifications and other embodiments of the invention set forth herein will come to mind to one skilled in the art to which these embodiments pertain having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for collecting residence information, the method comprising:
electronically receiving a request from a third-party to collect residence information associated with an address, wherein the residence information is to be collected as part of an in-person visit to the address;
electronically identifying a delivery route corresponding to the address;
electronically incorporating the address to the delivery route;
transmitting the delivery route comprising the incorporated address to a delivery driver's computing device, wherein the delivery driver is scheduled to drive the delivery route;
electronically receiving the residence information associated with the address, the residence information collected from an in-person visit to the address by the delivery driver;
and electronically providing the residence information to the third-party.

2. The method of claim 1, wherein the residence information is for a peer-to-peer loan transaction.

3. The method of claim 1, wherein the delivery driver's computing device is a handheld device.

4. The method of claim 1 further comprising electronically providing visual instructions to the delivery driver to visit the address.

5. The method of claim 1, wherein collecting the residence information further comprises delivering an item to the address.

6. The method of claim 1, wherein the residence information is input into the delivery driver's computing device by the delivery driver.

7. An apparatus comprising at least one processor and at least one memory including computer program code, the at least one memory and the computer program code configured to, with the processor, cause the apparatus to at least:
receive a request from a third-party to collect residence information associated with an address, wherein the residence information is to be collected as part of an in-person visit to the address;
identify a delivery route corresponding to the address;
incorporate the address to the delivery route;
transmit the delivery route comprising the incorporated address to a delivery driver's computing device, wherein the delivery driver is scheduled to drive the delivery route;
receive the residence information associated with the address, the residence information collected from an in-person visit to the address by the delivery driver; and
provide the residence information to the third-party.

8. The apparatus of claim 7, wherein the residence information is for a peer-to-peer loan transaction.

9. The apparatus of claim 7, wherein the delivery driver's computing device is a handheld device.

10. The apparatus of claim 7, wherein the memory and computer program code are further configured to, with the processor, cause the apparatus to provide visual instructions to the delivery driver to visit the address.

11. The apparatus of claim 7, wherein collecting the residence information further comprises delivering an item to the address.

12. The apparatus of claim 7, wherein the residence information is input into the delivery driver's computing device by the delivery driver.

13. A computer program product for collecting residence information, the computer program product comprising at least one computer-readable storage medium having computer-readable program code portions stored therein, the computer-readable program code portions comprising:
an executable portion configured to receive a request from a third-party to collect residence information associated with an address, wherein the residence information is to be collected as part of an in-person visit to the address;
an executable portion configured to identify a delivery route corresponding to the address;
an executable portion configured to incorporate the address to the delivery route;
an executable portion configured to transmit the delivery route comprising the incorporated address to a delivery driver's computing device, wherein the delivery driver is scheduled to drive the delivery route;
an executable portion configured to receive the residence information associated with the address, the residence information collected from an in-person visit to the address by the delivery driver; and
an executable portion configured to provide the residence information to the third- party.

14. The computer program product of claim 13, wherein the residence information is for a peer-to-peer loan transaction.

15. The computer program product of claim 13, wherein the delivery driver's computing device is a handheld device.

16. The computer program product of claim 13 further comprising an executable portion configured to provide visual instructions to the delivery driver to visit the address.

17. The computer program product of claim 13, wherein collecting the residence information further comprises delivering an item to the address.

18. The computer program product of claim 13, wherein the residence information is input into the delivery driver's computing device by the delivery driver.
